(19) United States
(12) Patent Application Publication
(10) Pub. No.: US 2016/0348280 A1
(43) Pub. Date: Dec. 1, 2016

(54) FUNCTIONALIZED MOLDED CELLULOSE BODY AND METHOD FOR PRODUCING THE SAME

(71) Applicant: Lenzing Aktiengesellschaft, Lenzing (AT)

(72) Inventors: Kurt Christian Schuster, Vöcklabruck (AT); Mohammad Abu Rous, Vöcklabruck (AT); Karl Michael Hainbucher, Schörfling (AT); Doris Richardt, St. Georgen (AT); Sigrid Redlinger, Lenzing (AT); Heinrich Firgo, Vöcklabruck (AT); Gert Kroner, Lenzing (AT)

(21) Appl. No.: 15/231,243

(22) Filed: Aug. 8, 2016

Related U.S. Application Data
(63) Continuation of application No. 13/519,369, filed on Aug. 24, 2012, now abandoned.

(30) Foreign Application Priority Data
Dec. 28, 2009 (AT) A 2040/2009

(51) Int. Cl. D01F 2/00; D01D 10/00; C08K 5/01; D01D 5/06; C08L 1/02; C08K 5/092

(52) U.S. Cl. CPC D01F 2/00; C08L 1/02; C08K 5/092; C08K 5/01; D01D 5/06; D01D 10/00

(57) ABSTRACT

The invention relates to a molded cellulose body which includes a functional substance having low impregnation efficiency, to the use thereof and to a method for introducing functional substances of low impregnation efficiency into a molded cellulose body during its production and after the molding step.

### CROSS REFERENCED TO RELATED APPLICATION

This application is a continuing application of U.S. patent application Ser. No. 13/519,369, filed Jun. 27, 2012, which is a national stage filing under 35 U.S.C. §371 International Application No. PCT/AT2010/000479, filed Dec. 15, 2010 which claims priority to Austrian Application No. A 2040/2009 filed Dec. 28, 2009, the entire disclosure of each of which is incorporated by reference herein.

### BACKGROUND OF THE INVENTION

The present invention relates to a method for introducing functional substances having low impregnation efficiency into a molded cellulose body, wherein the introduction into a never dried molded cellulose body takes place during its production and after the molding step, without chemical modification. It thus represents a novel path for functionalizing Lyocell fibers, by which functional substances can be incorporated, which cannot be achieved with conventional processes, or which can only be achieved at substantially higher cost.

### PRIOR ART

Cellulose textiles and fibers can be functionalized or chemically modified in different ways. For example, substances can be incorporated by spinning during the fiber production. Even after the fiber production itself, a chemical derivatization can still occur during the process, resulting in the formation of covalent bonds. Moreover, the fiber can converted by mechanical processing into intermediate forms, such as, yarn, cloth, knitted fabric or nonwoven fabric, or it can be processed to the finished textile, and modified at the end or during the textile production by processes, such as, dyeing, damping, or by the application of substances by means of binders.

Adding by spinning requires a good distribution of the additive, so that the spinnability in the process and sufficient mechanical fiber properties of the end product are maintained. Substances to be introduced thus have to be soluble in the spinning mass, or they have the capability of forming an even and stable dispersion of sufficiently small particles. Moreover, under the process conditions, and for the residence time in the process, the additive must be chemically stable. In the Lyocell process, examples are the production of matted fibers by the addition of TiO₂ pigment, the production of spin dyed fibers using dispersed soot (Wendler et al. 2005) or addition of vat dyes by spinning (Manian, A. P., Rüf, H., Bechtold, T., “Spun-Dyed Lyocell,” Dyes and Pigments, 74 (2007) 519-524), the production of fibers having ion exchange properties (Wendler, F., Meister, F., Heinze, T., Studies on the Thermostability of Modified Lyocell Dopes. Macromolecular Symposia 223(1), PG: 213-224 (2005)) or high water adsorption by means of superabsorbents (U.S. Pat. No. 7,052,775).

In the Lyocell process, the solvent NMMO can trigger chemical reactions that are capable of destroying sensitive substances, but it may also destabilize the spinning mass itself and result in exothermicity: for example, substances having an acidic effect are hazardous in this regard. In addition, volatile substances or substances that are volatile in steam can evaporate away in the Filmtruder in which the cellulose is brought into solution by water evaporation in a vacuum.

Chemically unstable substances include hydrolyzable substances such as esters (for example, fats and oils), amides (for example, proteins), and alpha-glycosidically bound polysaccharides (for example, starches), and also oxidation sensitive substances that are oxidized by NMMO (for example, antioxidants and vitamins).

In addition, there are substances that are difficult to remove from the spinning bath and consequently make the solvent recovery more difficult. A relevant example consists of paraffins which are used as phase change materials (PCM) among other purposes. Octadecane is used as phase change material. It can be enclosed by microencapsulation, and the microcapsules can be applied by means of binders to textile materials. Moreover, a description is provided showing how octadecane or similar materials can be incorporated by spinning into Lyocell fibers as microcapsules (EP1658395) or in pure form.

A more recent Japanese patent application (JP 2008-303245) describes the incorporation by spinning of olive oil in viscose and cupro fibers with antioxidant action. Here too, the incorporation by spinning has the great disadvantage that the closed circulation loops become soiled in the spinning process, and the fiber properties exhibit poorer mechanical fiber properties in comparison to oil-free fibers.

From WO 2004/081279, it is known to produce cationized fibers in the viscose process by spin coating a cationic polymer. Lyocell films with polyDADMAC have also already been produced (Yokota, Shingo; Kitaoka, Takuya; Wariishi, Hiroyuki, Surface morphology of cellulose films prepared by spin coating on silicon oxide substrates pretreated with cationic polyelectrolyte, Applied Surface Science (2007), 253(9), 4208-4214). Incorporation by spinning into Lyocell fibers is also possible; however, a fiber that has been functionalized in this manner, like all cationic substances, absorbs dyes and other contaminants out of the spinning bath. This results in problems due to discoloration, which constitutes a great disadvantage for the final product.

Cationic starches have also been incorporated by spinning into Lyocell fibers (Nechwatal, A.; Michels, C.; Kosan, B.; Nicolai, M., Lyocell blend fibers with cationic starch: potential and properties, Cellulose (Dordrecht, Netherlands) (2004), 11(2), 265-272). These substances were thus all introduced by incorporation by spinning, and not by a subsequent treatment.

The dissolution of proteins has already been described in the Lyocell base patent of Johnson 1969 (GB 1144048). Numerous additional patents for adding proteins by spinning exist, for example, WO 2002044278 and JP 2001003224. The Japanese document describes the incorporation by spinning of milk protein in viscose. However, due to the hydrolytic activity of NMMO, the efficiencies are low in practical spinning processes, and the degradation products contaminate the spinning bath and make the solvent recovery difficult. In addition, in biologically active proteins, such as enzymes, an uncontrolled hydrolytic degradation or a structural modification is often not acceptable for reasons pertaining to quality.

The use of gelatin as biocompatible material has been described numerous times. (for example, Talebian et al. 2007). The advantages include good swelling in water, biocompatibility, biodegradability, a non-sensitizing behavior, as well as the low costs of the material. However, the use of gelatin as material is restricted due to the very limited mechanical load bearing capacity of molded bodies, for example, films made of gelatin. Known solutions in this context are the application of thin layers on substrates, and crosslinking, for example, with bifunctional aldehydes. Our novel approach is the generation of a gelatin-containing surface by inclusion of gelatin in the Lyocell fiber pores. The mechanical properties of the composite material are determined here by the Lyocell fiber, while the biological properties of the fiber surface are determined by the gelatin.

Indeed, it is known from EP 0878133 or DE 1692203, for example, to introduce gelatin into food wrappers and packaging films made of cellulose. From AT 007617 U1 it is known to introduce gelatin by incorporation by spinning into viscose fibers. However, the efficiencies of this process, according to AT 007617 U1, are only approximately 15-45%; most of the gelatin is thus lost in the process.

Moreover, it is known from WO 97/07266 to introduce gelatin into a spinning solution for producing Lyocell fibers. The introduction of nucleophilic substances, for example, gelatin, in the spinning bath, is also claimed therein, but it is not described further. If gelatin is present in the spinning bath, this still has disadvantages similar to direct incorporation by spinning. Although the gelatin is less stressed thermally, it is stressed by the pH of the spinning bath and the hydrolytic activity of the 20-30% NMMO. In addition, the closed circulation loop of solvent is soiled with gelatin, which leads to difficulties in the solvent recovery.

In textile technology, a broad gamut of processes exists, in which the cellulose textiles are chemically modified. Dyes are introduced into the fiber from aqueous solutions during dyeing, or fixed to the textile by means of a binder during printing. Depending on the chemical nature, the dye adheres due to its chemical affinity for the cellulose (direct dyes), it forms insoluble aggregates in the fiber (for example, vat dyes) due to a reaction after the penetration into the fiber, or it forms covalent chemical bonds with the cellulose (reactive dyes). In the context of the present invention, the direct dyes are particularly relevant.

The introduction of direct dyes into cellulose textiles occurs basically by immersion of the textile in a solution of the dye, optional heating, and drying of the textile. The binding of the dye to the inner surface of the cellulose fibers is produced due to strong noncovalent interactions and requires no chemical reaction. The property of the dye to diffuse out of the solution preferentially into the fibers and to become incorporated therein is referred to as substantivity. The substantivity has the effect that the distribution of the dye between the solution and the fiber is situated much more to the fiber side. The distribution coefficient, that is the ratio of dye concentration in the substrate (textile) to the dye concentration in the dyeing bath under the condition of an extract dyeing, is a measure of this distribution under equilibrium conditions. Molecules having a high distribution coefficient K between the substrate and the solution are also referred to as having a high substantivity. The following holds true for the distribution coefficient and thus as a measure of the substantivity:

K=D_{f}/Dₛ

where D_{f} is the dye concentration in the substrate [mmol/kg] and Dₛ is the dye concentration in the solution [mmol/L]. For direct dyes, this distribution coefficient K is 10-100 L/kg or even higher (Zollinger, H., Color Chemistry, 2nd, Revised Edition, Verlag Chemie, Weinheim, 1991).

Other functionalities can be achieved by synthesizing polymers on the textile itself, for example, a wrinkle-free finish, also referred to as “high-grade finish” or “resin finish.” Other substances may also be included in such resin finishes. For example, the silk protein sericin has been fixed by means of a high-grand finish (A. Kongdee; T. Bechtold; L. Teufel, “Modification of cellulose fiber with silk sericin,” Journal of Applied Polymer Science, 96 (2005) 1421-1428), and chitosan has been applied to textiles. A disadvantage of such a resin bonding is that sensitive biomolecules lose their functionality, or that surfactant substances may lose their effect due to inclusion in the resin.

The never dried state of Lyocell fibers is the state in which the fibers are after the spinning process, the regeneration of the cellulose from the spinning solution, and the removal by washing of the solvent NMMO prior to the first drying step. Lyocell fibers that are in the never dried state differ from those that are in the dried and rehumidified state by a substantially higher porosity. This porosity has already been characterized extensively (Weigel, P.; Fink, H. P.; Walenta, E.; Ganster, J.; Remde, H. Structure formation of cellulose man-made fibers from amine oxide solution. Cellul. Chem. Technol. 31: 321-333; 1997; Fink, H P; Weigel, P.; Purz, H., Structure formation of regenerated cellulose materials from NMMO solutions. Prog. Polym. Sci. 26: 1473; 2001; Vickers, M.; N P Briggs, R I Ibbett, J J Payne, S B Smith, Small-angle X-ray scattering studies on Lyocell fibers; Polymer 42 (2001), 8241-8242;). Similarly, the water uptake of the fiber is higher in the never dried state. Other authors also report a strong increase in the crystallinity during the drying (Wei, M., Yang, G. et al., Holzforschung 63, 23-27 (2009)) based on the evaluation of broad angle X-ray scattering.

Typical Properties of Never Dried and of Dried Lyocell Fibers

| | | | | | Mean pore | |
|---|---|---|---|---|---|---|
| | | | Orientation | Cluster | diameter, wet, | |
| | | Crystallinity | as FWHM | diameter | according | Pore |
| State | WRV | (2) | in ° (1) | (nm) (3) | to SAXS (1) | length (1) |
| Never dried | 110% | approximately | 19° | 17 | 5.2 nm | 500 nm |
| | | 15% | | | | |
| Dried 1 time | — | approximately | 13° | 25 | — | 160 nm |
| | | 55% | | | | |
| Dried 1 time | 60-70% | — | 24° | — | 2.7 nm | 40 nm |
| (technical) | | | | | | |
| and | | | | | | |
| rehumidified | | | | | | |

(1) from Vickers et al. 2001. FWHM, Peak broadening in small angle X-ray scattering (full width at half maximum), a measure of the orientation

(2) from Wei et al., 2009

(3) from Fink et al., 2001

Lyocell fibers in the never dried state (prior to the first drying) are very accessible to water, but also to dissolved molecules. This circumstance is exploited for the chemical modification. Commercially used examples are crosslinking reactions for producing fibrillation-free fibers, with NHDT (Rohrer, C.; Retzl, P.; Firgo, H., Lyocell L F—profile of a fibrillation-free fiber, Chem. Fibers Int. 50: 552, 554-555; 2000) or TAHT (P. Alwin, Taylor J., Melliand Textilberichte 82 (2001), 196). The chemical modification assumes that the reagents penetrate into the never dried fibers, and that the reaction, under the process conditions, runs at a sufficiently high rate, and to completion, enabling the reagents to bind covalently to the fibers.

Compared to the prior art, the problem therefore is to provide a design or a method by means of which functionalities can be incorporated in cellulose fibers, functionalities which cannot be achieved at all with conventional processes, or which only can be achieved in a substantially more complicated manner.

### SUMMARY OF THE INVENTION

This problem is solved by a method for introducing functional substances into a molded cellulose body, characterized in that the introduction into a never dried molded cellulose body takes place during its production, after the molding step, while preserving the chemical structure of the functional substance. Thus, no change in the chemical structure of the functional substance should occur, for example, due to derivatization and similar processes.

The method according to the invention makes it possible, indeed for the first time, to permanently introduce functional substances having a low impregnation efficiency K′, particularly an impregnation efficiency K′ of less than 10, and preferably less than 5, into a molded cellulose body.

Dyes usually have a chemical structure which results in a high affinity for the material to be dyed, in order to allow a high efficiency and rate in the dyeing process. In the literature on dyes, the affinity of a dye for a fiber is described using the distribution coefficient K (H. Zollinger, Color Chemistry, V C H, 1991, p. 275). The following holds: K=D_{f}/Dₛ, where Dₛ is the equilibrium concentration in the solution (in g/L), and Df is the equilibrium concentration on the fiber (g kg). The value K is a thermodynamic parameter.

The impregnation efficiency K′ used for the purposes of the invention described here characterizes the affinity of a substance for a fiber made available to it. It applies for the combination of a substance with a certain fiber type under certain process conditions, for example, a certain impregnation duration, here 15 min, and temperature. Strictly speaking, it is a kinetic parameter, because a thermodynamic equilibrium is generally not reached with the impregnation durations used.

An impregnation efficiency of exactly 1.0 for a certain substance in a certain solvent under certain conditions means that the substance is distributed on the fiber in the same manner as the solvent itself. On the other hand, an impregnation efficiency of less than 1.0 indicates that exclusion effects are present and thus that the fiber has a higher affinity for the solvent (in many cases water) than for the substance. Conversely, an impregnation efficiency of more than 1.0 indicates that the fiber has a stronger affinity for the substance than for the solvent. Consequently, under the conditions under which they are used (increased temperatures of more than 80° C., addition of salts), dyes always have an impregnation efficiency that is clearly greater than 1.0, and usually greater than 10, even up to 100 and more, because they should be absorbed as completely as possible on the fibers. Here are several examples of the impregnation efficiency K′ of common dyes:

| | Impregnation | | |
|---|---|---|---|
| Dye | duration | Temperature | K′ |
| Blue (Solophenyl Blue | 15 min | 50° | 43 |
| Marine BLE) | | | |
| Blue (Solophenyl Blue | 15 min | 95° | 154 |
| Marine BLE) | | | |
| Blue (Solophenyl Blue | 60 min | 50° | 175 |
| Marine BLE) | | | |
| Blue (Solophenyl Blue | 60 min | 95° C. | >200 |
| Marine BLE) | | | |
| Red (Sirius Scarlet BN) | 15 min | 95° C. | >200 |
| Red (Sirius Scarlet BN) | 60 min | 95° C. | >200 |
| Yellow (Sirius Light | 15 min | 95° C. | >200 |
| Yellow GD) | | | |
| Yellow (Sirius Light | 60 min | 95° C. | >200 |
| Yellow GD) | | | |

### BRIEF DESCRIPTION OF THE FIGURES

FIGS. 1a-1d: Fibers with coconut fat from Example 3:1. Dyeing. Rhodamine B: FIG. 1a: before a wash, cross section (thin section 20 μm), 800× magnification; FIG. 1b: after 3 washes, cross section (thin section 20 μm), 800× magnification; FIG. 1c: before a wash, longitudinal view, 800× magnification; FIG. 1d: after three washes, longitudinal view, 800× magnification;

FIGS. 2a and 2b: Fluorescence microscopy view of the FITC-dyed fiber with “high gel strength” gelatin after 3 washes from Example 7: FIG. 2a: Longitudinal view; FIG. 2b: Thin section (10 μm); and

FIG. 3: Fluorescence microscopy view in the confocal laser microscope of a microtome cross section of a FITC-dyed fiber with whey protein according to Example 8.

### DETAILED DESCRIPTION OF THE INVENTION

In one embodiment, the procedure used during the dyeing to determine the impregnation efficiency was as follows:

Dried or never dried (moisture content 100%) Lyocell fibers were processed at a liquor ratio of 1:20 in the Labomat laboratory dyeing apparatus (Company Mathis, Oberhasli/Zurich, Switzerland) with 1.5 g/L of the corresponding dye. For this purpose, the liquor was heated to 55° C., the fiber flock was added (cooled in the process to 50° C.), and processed for the indicated duration. Subsequently, the fiber flock was separated, compressed at 3 bar (yielded a moisture of approximately 100%), and the supernatant liquor was analyzed by photometry for its dye content. In the treatment at 95° C., the liquor was preheated to 65° C., the fiber was added, heated at 4° C./min, and processed for the indicated duration.

Functional substances applied particularly advantageously by the method according to the invention may include:

Hydrophobic (lipophilic) substances having a low or high molecular weight, for example,

oils, such as, olive oil, grapeseed oil, sesame oil, linseed oil,

fats, such as, coconut fat,

paraffins and other hydrocarbons,

waxes, such as wool wax and its derivatives, beeswax, carnauba wax, jojoba oil,

resins, such as, shellac,

oils, fats, waxes, etc., which are used as substrates for fat soluble active ingredients, for example, for skin-care vitamins, ceramides,

fire retardant substances which are soluble or emulsifiable in organic solvents,

dyes that are soluble in special solvents, for example, the so-called “High-VIS” dyes

insecticides, for example, pyrethroids, such as, permethrin.

Hydrophilic, uncharged polymers, for example,

neutral polysaccharides, for example, xylan, mannan, starches and starch derivatives.

Anionic polymers, for example,

polyacrylic acid, polymethacrylic acid,

polysaccharides with anionic groups, such as, polygalacturonate (pectin), carrageenan, hyaluronic acid.

anionic derivatives of neutral polymers

Cationic polymers, for example,

polyDADMAC, polyamino acids, . . . .

cationic derivatives of neutral polymers, for example, cationized starches

Proteins, for example,

structural proteins: gelatin, collagen, milk proteins (casein, whey proteins)

enzymes

functional proteins

Combinations of substances—complex natural substances, for example,

cosmetically active substances, such as, Aloe vera, grapeseed extract or oil, antioxidant mixtures of plant origin, etheric oils,

wellness preparations, such as, Ginseng.

In the method according to the invention, the functional substance should be dissolved in a suitable solvent, or in the form of a liquid emulsified in a suitable emulsion medium. Substances in the form of solid particles cannot be introduced into a molded cellulose body using the method according to the invention.

In principle, all types of molded cellulose bodies are suitable for the method according to the invention. It is preferred to treat fibers, films or particles in this manner. Here, fibers denote endless filaments as well as cut staple fibers with conventional dimensions, and short fibers. Films denote laminar molded cellulose bodies, wherein the thickness of these films is in principle unlimited.

The molding step occurs preferably by extruding a cellulose-containing spinning solution through an extrusion nozzle, because, in this manner, large quantities of the molded cellulose bodies with very consistent shape can be produced. For the production of fibers, one can consider using methods with conventional draw-off devices after the extrusion nozzle, or alternative methods, particularly melt blowing methods. In order to produce films, one can use slit nozzles for producing flat films or annular slit nozzles for producing tubular films. But additionally other molding methods can also be used, for example, methods that use a doctor blade for producing films. All these methods are in principle known to the person skilled in the art.

Additional possible molded cellulose bodies are particulate structures, such as, granulates, spherical powders or fibrides. The production of spherical cellulose powders, using a granulate as starting material, has been described in WO 2009036480 (A1), and that of fibride suspensions in WO2009036479 (A1). As long as these particle systems are in the never dried state, an application, according to the invention, of active substances is possible.

Additional possible molded cellulose bodies are spunbond materials (“melt blown”), sponges, hydrogels, and aerogels.

The accessibility of the inner structure of a molded cellulose body, and thus the impregnation efficiency, can in principle be increased by the production of a porous molded body. Methods for increasing the porosity are known to the person skilled in the art.

The cellulose-containing spinning solution is preferably a spinning solution produced according to a direct dissolution method, particularly according to the Lyocell method. The production of such a spinning solution is known in principle to the person skilled in the art from numerous publications of the last decades, such as WO 93/19230, among others. This represents a particular advantage of the present invention in comparison to the incorporation of functional substances by spinning, because the known methods, particularly in the areas of spinning solution production and solvent recovery, do not have to be modified extensively for the adaptation to the properties of functional substances.

The method according to the invention can be applied to molded cellulose bodies that are chemically crosslinked in the never dried state, in order to reduce the fibrillation tendency in the case of Lyocell fibers, for example. Here, the method according to the invention can be carried out before or also after the chemical crosslinking. Similarly, the method according to the invention is suitable for use on molded cellulose bodies which contain substances that have already been incorporated by spinning, such as, organic and inorganic matting agents, flame retardants, etc.

According to the invention, the introduction occurs in particular between the exit of the molded cellulose body from the precipitation bath and the drying of the molded cellulose body that has been treated in this manner. It is only in this area that the functional substances to be introduced are found in the method. The closed circulation loops of substance required for this purpose can be closed off very easily here and they can be separated completely, for example, separated from the boiling closed circulation loops during the production of the spinning solution, and from the closed circulation loops during the solvent recovery. In addition, the functional substances are thus not exposed to high temperatures, low pressures, or other disadvantageous conditions. In this manner essential problems of the prior art are solved.

Depending on the specific nature of the functional substance to be introduced, it is also possible simply to carry out the introduction after a solvent exchange, at this site in the method. This solvent exchange can also take place using process steps and devices that are in principle known. In the examples according to the invention, a corresponding procedure is described as an example. The transfer to large-scale industrial procedures is possible for the person skilled in the art without any problem and without further inventive step.

To fix the functional substance in the molded cellulose body, the latter can preferably be treated with steam after the introduction of the functional substance. Treating with steam according to the invention refers to a treatment at elevated temperature in a steam atmosphere, particularly in a saturated water vapor atmosphere at an appropriate temperature, which is preferably above 80° C., and which has only an upper limit depending on the thermal stability of the participating substances, on the pressure resistance of the apparatuses used, as well as on the cost effectiveness. Usually, temperatures between 90 and 120° C. will be appropriate. This process step can be carried out in a simple way, for example, in an appropriate, possibly already present, secondary treatment area on the fiber line.

The present invention further relates to a molded cellulose body which contains a functional substance having an impregnation efficiency K′ of less than 10, preferably less than 5, and which has been produced according to the above-described method.

The essential difference compared to a molded cellulose body in which, in each case, the same identical substance was incorporated by spinning according to the prior art consists in that the functional substance, in the molded body according to the invention, presents no modifications due to the high temperatures occurring in the production process or due to the hydrolytic activity of the NMMO solvent. Such modifications can be observed by the person skilled in the art on the basis of the characteristic degradation products or also on the basis of the chemical or structural modifications on the functional substance in the finished molded cellulose body.

The molded cellulose body which can be produced by the above-described method has a continuous, nonconstant distribution of the concentration of the functional substance with the minimum in the center of the molded body. This means, in other words, that the concentration of the functional substance is lower in the interior of the molded body than in its outermost layer. The concentration here does not decrease abruptly, as would be the case, for example, if the coat application occurred at a later time. In principle, the functional substance is present everywhere in the cross section of the molded body, except possibly in the center of the molded body. During further processing, it may be possible to wash the functional substance out of the outermost layer only. This distribution of the functional substance is typical for the molded body according to the invention, and it cannot be achieved with any of the methods known in the prior art.

The distribution of the functional substance can be determined by known methods, for example, by the photometric evaluation of a thin layer microphotograph or by spatially resolved spectroscopy methods, such as EDAX or spatially resolved Raman spectroscopy, on cross sections of the molded body according to the invention.

The functional substance preferably has an impregnation efficiency K′ of less than 10, and preferably less than 5.

The molded cellulose bodies according to the invention preferably contain functional substances that are not sufficiently stable in NMMO to interfere with the NMMO recovery or affect the spinning safety, as oils do, for example.

It is particularly preferred to select the functional substance in the molded cellulose bodies according to the invention from the substance group consisting of

a. hydrophobic (lipophilic) substances having a low or high molecular weight, for example, oils, such as, olive oil, grapeseed oil, sesame oil, linseed oil, fats, such as, coconut fat, paraffins and other hydrocarbons, waxes, such as, wool wax and its derivatives, beeswax, carnauba wax, jojoba oil, resins, such as, shellac, oils, fats, waxes, etc. which are used as substrates for fat soluble active ingredients, for example, for skin-care vitamins, ceramides, fire retardant substances which are soluble or emulsifiable in organic solvents, dyes which are soluble in special solvents, for example, the so-called “High-VIS” dyes, insecticides, for example, pyrethroids, such as, permethrin,

b. hydrophilic, uncharged polymers, for example, neutral polysaccharides, for example, xylan, mannan, starches and their derivatives,

c. anionic polymers, for example, polyacrylic acid, polymethacrylic acid,

d. polysaccharides having anionic groups, such as, polygalacturonates (pectin), carrageenan, hyaluronic acid,

e. anionic derivatives of neutral polymers,

f. cationic polymers, for example, polyDADMAC, polyamino acids, cationic derivatives of neutral polymers, for example, cationized starches,

g. proteins, for example, structural proteins: gelatin, collagen, milk proteins (casein, whey proteins), enzymes or functional proteins,

h. combination of complex natural substances, for example, cosmetically active substances, such as, Aloe vera, grapeseed extract or oil, antioxidant mixtures of plant origin, etheric oils, or wellness preparations, such as, Ginseng.

According to the invention, these molded bodies can be used for preparing yarns, textiles, gels or composite materials.

The invention can be used both in a wide variety of technical fields and also in medicine, and in cosmetics and wellness.

In medicine, materials for wound treatment or wound healing are frequently constructed from a substrate which determines the mechanical properties, and from a biocompatible coating material which is particularly compatible with the skin and with the surface of the wound. Such composite materials can be produced, due to the invention, in a relatively simple manner, with Lyocell fibers as substrate and enclosed biomolecules, for example, gelatin or hyaluronic acid.

In an additional use, or in combination with wound compatible materials as above, pharmaceutical active ingredients which are released slowly and in a controlled manner can be incorporated.

Biocompatible surface modifications of fiber and textile materials or of films are also used as substrate for the growth of cell cultures, to produce synthetic tissues, as so-called scaffolds, or to colonize implants with physiological cells.

Functional proteins, such as, enzymes, are frequently immobilized for technical use according to the prior art. In the chemical binding to a substrate, one often must expect activity losses, if the binding by chance occurs in the vicinity of the active center, or if the structure of the protein is modified by the binding reaction. Functional proteins and enzymes can be bound permanently according to the invention to a textile substrate material by inclusion in the pores of a never dried fiber. This represents a possibility of immobilizing proteins without covalent chemical binding, which also avoids the above-described disadvantages of the known immobilization methods.

Active ingredients for producing fire retardant textiles are fixed according to the prior art by being incorporated by spinning in chemical fibers or by applying a finish to the finished textile. Substances that are applied in the finish are often no longer wash resistant. Some fire retardant agents cannot be introduced by spinning into Lyocell fibers, because they interfere with the solvent recovery. For such substances, which are soluble in organic solvents, a binding by impregnation of the fibers with a solution and by inclusion during the drying can occur according to the invention.

The molded bodies according to the invention can also be used for producing dyed, particularly High-Vis dyed products. Composite fibers made of cellulose and proteins can be produced according to the invention by inclusion of dissolved proteins in the never dried Lyocell fiber.

Cosmetic textiles represent an increasingly rewarding market. Dry skin affects a growing proportion of the population, because this problem occurs more frequently with increasing age. In cosmetics, moisture-containing active ingredients are therefore used in order to improve the dry skin state. There have been indications that water binding fibers are capable of improving the moisture balance of the skin (Yao, L., Tokura, H., Li Y., Newton E., Gobel M. D. I., J. Am. Acad. Dermatol. 55, 910-912 (2006)). Here the comparison of cotton and polyester already showed that cotton had a clearly positive effect on the moisture of dry skin. More strongly water-binding textiles made of Lyocell, with additional water binding functionality consisting of a milk protein introduced according to the invention, for example, will therefore continue and reinforce this trend.

Care oils are known for their positive effect on the skin. Oils and fats smoothen and protect the skin (Lautenschläger, H., Fettstoffe—die Basis der Hautpflege. Kosmetische Praxis 2003 (6), 6-8). In cosmetics, almond oil and grapeseed oil, for example, are currently used among others. These oils can be enclosed by the method according to the invention in Lyocell fibers from which they are slowly released. Wool wax contains cholesterol which has an important barrier function on the skin (Lautenschläger, H., Fettstoffe—die Basis der Hautpflege. Kosmetische Praxis 2003 (6), 6-8). The cosmetic literature also describes (Lautenschläger, H., Essentielle Fettsäuren—Kosmetik von innen and auβen. Beauty Forum 2003(4), 54-56) that linoleic acid can be introduced from cosmetics into the skin. This substance is an essential fatty acid and it counteracts barrier dysfunctions.

The role of micronutrients has been studied increasingly in recent years. According to Kugler 2006 (Kugler, H.-G., UV Schutz der Haut. CO-Med 2006 (3), 1-2) it is incontestable that the intensity of UV radiation has increased in recent years, which entails an increased need for skin protection measures. This includes unquestionably appropriate skin protection clothing, sunscreens, but also precisely a so-called “internal skin care” by means of an antioxidant rich nutrition and optimal supply with micronutrients.

Micronutrients as nutrition components are recognized to be important for the health of the skin. Many can be absorbed through the skin. Micronutrients are used increasingly in cosmetic preparations. The release of such substances by a textile represents an interesting alternative to application on the skin. On the one hand, the application process is omitted. On the other hand, the release is distributed over longer time periods, and can result in particularly positive effects when the substances that are needed in small quantities.

Radical scavengers are interesting products in the wellness area. The protection of the cells of the human body from oxidative stress plays an important role in maintaining the health of all the organs, but particularly that of the skin (Lautenschläger, H., Radikalfänger—Wirkstoffe im Umbruch. Kosmetische Praxis 2006 (2), 12-14). There have been reports of antioxidative effects of various vitamins (C, E, A), phenolic substances from plants, but also of certain proteins, such as, gelatin (http://www.gelita.com/DGF-deutsch/index.html).

Micronutrients are reported to be connected with stress reduction (Kugler, H.-G., Stress and Micronährstoffe. Naturheilkunde 2/2007). In this context, amino acids are particularly recommended. Protein-containing fibers, for example, with milk protein, slowly release amino acids as a result of hydrolysis and can therefore contribute to the micronutrition of the skin, which is beneficial for the entire organism.

### EXAMPLES

The invention will now be described in reference to examples. The examples are to be understood as possible embodiments of the invention. The invention is in no way limited to the scope of these examples.

### Fiber Production:

Lyocell fibers were produced according to the teaching of WO 93/19230 and used in the never dried, freshly spun state. Viscose fibers and modal fibers were produced according to the conventional technical methods (Götze, Chemiefasern nach dem Viscoseverfahren. Springer, Berlin, 1967).

### Dry Weight Determinations:

“atro” below denotes the weight of the fiber as an absolute dry weight after drying at 105° C. for 4 hours.

### Coatings:

Coatings of substances are expressed as wt % with respect to 100% dry fiber.

Coating Determination by Extraction:

The extractable proportions are removed from the fiber by Soxhlet extraction, in ethanol unless otherwise indicated, and determined by gravimetry after the evaporation of the solvent.

Treatment with Steam:

The treatment with steam was carried out in the laboratory steaming apparatus (Type DHE 57596, Company Mathis, Oberhasli/Zurich, Switzerland) at 100° C. in saturated steam.

Washing of the Fiber and Textile Products:

“Simulated Household Wash:”

60° C., 30 min with 1.3 g/L ECE washing agent in 700 mL tap water in the Labomat laboratory dyeing apparatus (Type BFA 12, Company Mathis, Oberhasli/Zurich, Switzerland). In case of repeated washes, intermediate rinsings under flowing hard water were carried out, and the fibers were then compressed in the padding machine at 3 bar.

“Alkaline Household Wash:”

60° C., 30 min with 1 g/L Na₂CO₃, liquor ratio 1:50, in the Labomat laboratory dyeing apparatus.

### Wool Dyeing:

Formulation:

3% Lanaset Marine Blue (dye)

2 g/L sodium acetate

5% sodium sulfate calc.

2% Albegal SET

1 g/L Persoftal

4.5-5.0 pH (adjusted with acetic acid).

The procedure was started at 40-50° C. with all the additives, and allowed to run for 10 min. Then dye addition, continued dyeing for 10 min, then heating within 30-50 min to 98° C. (1.6° C./min), and dyeing for 20-40 min at 98° C., cooling to 80° C., and rinsing.

The color depth (intensity) of the wool dyeing was determined according to the CIELAB method.

### Standard Operating Procedure for Determining the “Impregnation Efficiency” of a Substance

Never dried Lyocell fibers are used as fiber samples. They are impregnated in an impregnation bath at a liquor ratio of 1:20 with a 5% solution of the substance in water or a 5% emulsion in the medium mentioned in each case, at a temperature of 50° C. for 15 min. For the impregnation, a laboratory dyeing apparatus of the “Labomat” type is used. The impregnation bath is here first preheated to the test temperature, and subsequently the fibers are added. Depending on the affinity of the functional substance, one of the following two methods is used for determining the impregnation efficiency.

Method 1: After an impregnation duration of 15 min, the decrease of the substance concentration in the impregnation bath is measured by photometry. This method is also suitable for substances with high affinity (K′ slightly higher than 5), because a clear decrease of the substance concentration in the solution occurs here. For substances with low affinity for the fiber, the difference in the substance concentration in the solution before and after impregnation would be too low to be measured reliably. Therefore, a second method is used in such cases. However, the values obtained with the two methods are clearly similar.

Method 2: After an impregnation duration of 15 min, the impregnated fibers are removed from the Labomat, compressed in the padding machine at 3 bar, and subsequently the moisture of the compressed fibers is determined. Then, the compressed fibers are dried at 105° C. for 4 hours in the drying cabinet. The substance concentration on these dry fibers are determined using an appropriate method, for example, for nitrogen-containing substances via nitrogen analysis (for example, Kjehldahl) and for fats via extraction and gravimetric determination of the extract. This method is also suitable for substances with low affinity.

In principle, it would be possible to change the solvent, the concentration of the substance offered, the temperature, and the apparatus used for the impregnation, in order to determine the impregnation efficiency under practical conditions, if certain substances cannot be impregnated advantageously under the above-mentioned conditions. The impregnation efficiency K′ is calculated using the following formula:

K′=Dft/Dso*100/F

where Dₛₒ is the starting concentration in the solution (in g/k), F the total coating in terms of moisture and active substance (in % with respect to the dry fiber weight as 100%) after compressing, and D_{ft} is the concentration on the fiber (in g/kg) at time t (=15 min).

Here, D_{ft} in method 1 is calculated from the concentration of the solution after the impregnation ( ):

D_{f}=(Dso−Dst)*V0

where Dₛₒ is the starting concentration of the functional substance in the solution (in g/L), V₀ the starting volume of the solution (in L), and Dₛₜ the concentration of the functional substance at time t=15 min in the solution (in g/L).

In method 2, D_{ft} is determined directly from the concentration on the fiber (coating).

### Example 1

### Binding of Wax from a Solvent

Wool wax alcohol is a hydrolysis product of lanolin (wool wax), which contains the alcohols of wool wax in pure form. The fatty acids, with which the native wool wax is esterified, are largely separated in the process during the production. As a result, the product is particularly durable and resistant against hydraulic cleavage. The batch of wool wax alcohol (Lanowax EP, Company Parmentier, Frankfurt, Del.) had the following properties: melting temperature 66° C.; saponification number 2.3 mg KOH/kg; acid number 0.97 mg KOH/g; cholesterol 31.4%; and ash 0.05%. According to the prospectus of the manufacturer, the composition of wool wax alcohols of pharmaceutical quality is as follows (average values): lanosterol and dihydrolanosterol: 44.2%, cholesterol: 32.5%; aliphatic alcohol: 14.7%; aliphatic diols: 3.2%; hydrocarbons: 0.9%; and unidentified: 4.5%.

50 g dry weight of a never dried Lyocell fiber with a titer of 1.3 dtex or 6.7 dtex were treated, without prior solvent exchange, with a solution of 10% wool wax alcohol (Lanowax EP, Company Parmentier, Frankfurt, Del., impregnation efficiency K′=0.74) in isopropanol at a liquor ratio of 1:20 for a time period of 10 min. The solvent exchange here took place in situ, and the residual water content in the entire preparation was calculated at 6.8%. The fibers were separated by compressing in the padding machine at 3 bar from the excess wax solution, and dried for 4 hours at 105° C. The resulting fibers were subjected to 3 washes at 60° C. (simulated household wash). The wax content was determined by gravimetry and by extraction in ethanol.

The fiber product, after drying, was hardly sticky at all, and it was easy to open.

Reference samples of dried fibers with 1.3 and 6.7 dtex were treated in the usual manner, except that the fibers were dried prior to impregnation at 105° C. for 4 hours. These samples clearly showed, on the basis of the clearly reduced wax coating after the third wash, that the wash resistance of the fibers that had been treated according to the invention was considerably better.

TABLE 1
Preparation of a wool wax alcohol-containing
fiber. Coatings in % after extraction.

| | Fiber | | | |
|---|---|---|---|---|
| | 1.3 dtex | 6.7 dtex | 1.3 dtex | 6.7 dtex |
| | Preliminary treatment | | | |
| | Never dried | Never dried | Dried | |
| Steps | Coating (%) | Coating (%) | Coating (%) | Coating (%) |
| After drying | 7.44 | 7.15 | 9.70 | 8.56 |
| After 2nd wash | 6.66 | 4.49 | — | — |
| After 3rd wash | 6.41 | 4.26 | 0.1 | 0.05 |
| After 3rd wash- | red | red | white | white |
| dyeing with | | | | |
| rhodamine B | | | | |

### Example 2

### Binding of polyDADMAC

Cationized fibers are produced, for example, as a filtration means. Cationic functions on cellulose fibers enable additional dyeing processes, which are not successful on pure cellulose, for example, dyeing with acidic wool dyes.

The cationic polymer polyDADMAC (poly(diallyldimethylammonium chloride), Sigma Product No. 522 376, extra low molecular weight, MW<100,000, impregnation efficiency K′=1.4 for never dried Lyocell, K′=1.14 for dried Lyocell, K′=0.87 or 0.75 for never dried or dried viscose) was applied in a 1% aqueous solution to never dried fibers, dried fibers, and knitted fabrics by impregnation (for 15 min), compressing in the padding machine at 1 bar, 10 min treatment with steam at 100° C. in saturated steam, drying for 4 hours at 105° C. The resulting fibers were then brightened (avivage B 306, diluted 1:3, LR 1:20), dried, carded, spun into yarn, and knitted.

A mild alkaline preliminary wash was carried out on the knitted fabrics.

For the detection of the polymer, an elemental analysis to determine nitrogen and a wool dyeing of the fibers or knitted fabrics produced therefrom were used. The color depth was determined by means of the CIELAB method. The darkness of the dyeing was determined from the luminance L, where darkness=100−L.

The persistence of the polyDADMAC coating was determined, on the one hand, on the fiber, and, on the other hand, on the produced knitted fabric after wool dyeing (as total nitrogen from polyDADMAC and wool dye), in each case after 5 household washes, by photometric measurement of the darkness (=100−brightness [L]) (see Table 2).

For comparison, known wool dyeable fibers were treated by the same dyeing process. The TENCEL® reference was a commercial 1.3 dtex/39 mm textile type from Lenzing AG. “Rainbow” is a cationized viscose fiber from Lenzing AG.

The color intensity and also the wash resistance of the TENCEL® fiber which had been functionalized according to the invention with polyDADMAC thus were in the range of wool and “Rainbow” viscose. This shows, on the one hand, the advantages of the method according to the invention compared to an impregnation, and, on the other hand, how a cellulose fiber having a good suitability for mixing with wool can be produced in a simple and effective manner.

TABLE 2

| | | Before wash | | After 5 washes | |
|---|---|---|---|---|---|
| | | % | | % | |
| | | PolyDADMAC | | PolyDADMAC | |
| Example | Sample | on fiber | Darkness | on fiber | Darkness |
| 2.1 | TENCEL ® | 2.5 | 83.3 | 1.6 | 77.1 |
| | never dried | | | | |
| 2.2 | Viscose never | 1.4 | 74.8 | 0.8 | 59.4 |
| | dried | | | | |
| 2.3 | Modal never | 0.9 | 66.9 | 0.4 | 46.9 |
| | dried | | | | |
| 2.4 | TENCEL ® | 1.4 | 73.9 | 1 | 60.6 |
| | predried | | | | |
| 2.5 | Viscose | 1.2 | 71.9 | 0.7 | 57.1 |
| | predried | | | | |
| 2.6 | Modal predried | 1.1 | 66.3 | 0.5 | 47.3 |
| 2.7 | Finished knitted | 0.8 | 72.2 | 0.5 | 61.9 |
| | fabric | | | | |
| | TENCEL ® | | | | |
| 2.8 | Finished knitted | 1.3 | 72.2 | 0.8 | 66.7 |
| | fabric viscose | | | | |
| 2.9 | Finished knitted | 0.9 | 65.2 | 0.2 | 48.4 |
| | fabric modal | | | | |
| 2.10 | TENCEL ® | 0 | 32.8 | not known | not known |
| | reference | | | | |
| 2.11 | Rainbow | 0 | 84.9 | 0 | 80.2 |
| 2.12 | Wool | 0 | 87.0 | 0 | 86.7 |

### Example 3

### Binding of Oils and Fats after Solvent Exchange

### Example 3.1

The coconut fat used (Ceres, Company VFI) had the following properties:

Melting point approximately 28° C.

Composition: Saturated fatty acids: 92 g

Simply unsaturated fatty acids 5 g

Multiply unsaturated fatty acids 2 g

Trans fatty acids 1 g

The impregnation efficiency K′ for this coconut fat, measured by impregnation after solvent exchange in ethanol, was 0.68. 39 g (atro) never dried Lyocell fibers with a titer of 1.3 dtex with a water content of 91.7 g were impregnated in anhydrous ethanol at a liquor ratio of 1:50 for 4 h, and in this manner the water was largely exchanged against ethanol. The resulting ethanol-moist fiber was centrifuged, and impregnated with a mixture of 40 wt % coconut fat in ethanol for 72 h under shaking. The remaining fiber was dried for 2 h at 60° C. in the vacuum drying cabinet, and subsequently for 2 h at 105° C. in the drying cabinet at atmospheric pressure. The fiber was washed in the washing machine using the washing bag and with 2 kg additional laundry at 60° C. with a washing agent without optical brightener (ECE color trueness washing agent), and weighed. The fiber was air dried overnight. The wash was repeated another 2× (3 washes). The fat content was determined by gravimetry and by extraction.

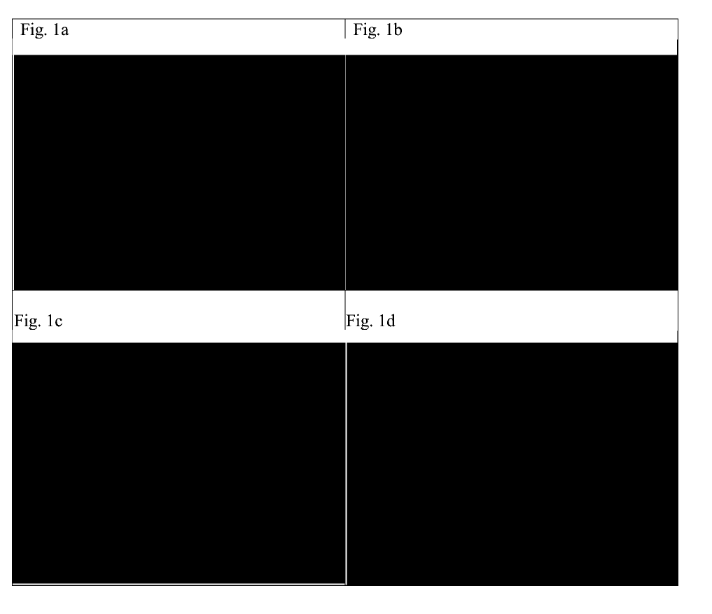

The distribution of the coconut fat in/on the fiber was made visible for the fibers before the washes and after the third wash, using fluorescence microscopy after dyeing with rhodamine B. The distribution was even over the cross section and along the fiber (FIG. 1a-FIG. 1d).

### Example 3.2

79 g (atro) never dried Lyocell fiber with a 1.3 dtex titer were placed for 2 h in ethanol (analytical grade) at a liquor ratio of 1:20 in the ultrasound bath. During that time period, the temperature increased to approximately 50° C. Subsequently a centrifugation was carried out for 5 min using a laboratory centrifuge (1475 rpm). Then, the fiber was placed with a 40% coconut fat/ethanol mixture also for 2 h in the ultrasound bath, and centrifuged for 15 min with the laboratory centrifuge. The fibers were then dried for 2 h in the vacuum drying cabinet at 60° C. and subsequently for an additional 2 h in the normal drying cabinet at 105° C. The fibers were then washed 3× with ECE color fastness washing agent at 60° C. in the washing bag (with approximately 2 kg adjacent fabric), and centrifuged at 1200 rpm.

The fibers were air dried after the washing. The fat coating before and after the washes was determined by ethanol extraction.

### Example 3.3

The impregnation efficiency K′ for this olive oil, measured with impregnation after solvent exchange in ethanol, was 0.89. 78 g never dried Lyocell fibers with a titer of 1.3 dtex were impregnated in anhydrous ethanol at a liquor ratio of 1:20 in the ultrasound bath for 2 h, and in this manner the water was largely exchanged against ethanol. The resulting ethanol-moist fiber was impregnated with a mixture of 40 wt % olive oil in ethanol for 2 h in the ultrasound bath. The fibers were separated by compressing in the padding machine at 3 bar from the excess fat solution, and dried for 2 h in the vacuum drying cabinet, and then for 2 h at 105° C. The fiber was then washed 3× with ECE color fastness washing agent at 60° C. in the washing bag (with approximately 2 kg adjacent fabric), and centrifuged at 1200 rpm. The fibers were air dried after the wash. The fat content was determined by ethanol extraction. Results see Table 3.

TABLE 3
Properties of the oil- and fat-containing fibers produced

| | | Fat/oil content (% coating) | | |
|---|---|---|---|---|
| | | Before | After 3 | Rhodamine B |
| Example | Substance | washes | washes | dyeing |
| 3.1 | Coconut fat | 19 | 16 | Red |
| 3.2 | Coconut fat | 18.5 | 17.6 | Red |
| 3.3 | Olive oil | 29.2 | 17.6 | Red |
| 3.4 | Reference | 0 | 0 | White |
| | untreated | | | |

### Example 4

### Binding of Paraffin after Double Solvent Exchange

100 g never dried Lyocell fibers with a titer of 1.3 dtex and a dry content of 19% were impregnated in anhydrous ethanol at a liquor ratio of 1:50 for 4 h, and centrifuged, and in this manner the water was largely exchanged against ethanol. A second solvent exchange with ethanol was carried out at a liquor ratio of 1:50, and then a solvent exchange with toluene at LR: 1:50 was carried out. The toluene-moist fiber so obtained was impregnated with a solution of 75 wt % octadecane in toluene for 4 h at 25° C. The impregnation efficiency in toluene after the described double solvent exchange was 0.18. The fibers were separated by centrifugation from the excess octadecane-toluene solution and dried in the air, then for 2 h at 60° C., and subsequently for 2 h at 120° C. The resulting fibers were subjected to 3 household washes (washing machine, 60° C., for 30 minutes, 2 kg polyester adjacent fabric, with air drying after each wash). The octadecane content was first determined by gravimetry and the extractable octadecane quantity was determined additionally by extraction in toluene in the Soxhlet extractor. It was found that only traces of octadecane were extractable. After acid hydrolysis of the fiber in 72.6% H₂SO₄ at 25° C., the hydrolysis product was extracted, and analyzed by gas chromatography, which resulted in the determination of the octadecane quantity that was actually enclosed within the cellulose structure.

TABLE 4
Fiber data of the fiber with octadecane

| | Titer | | | | | Octadecane content (%) | |
|---|---|---|---|---|---|---|---|
| | MW | Titer | FFk | FFk | FDk | By | After |
| Example | dtex | CV % | Mw | CV % | Mw % | gravimetry | hydrolysis |
| 4.1 | 1.36 | 13 | 31.8 | 17 | 9.5 | 20 | 12.7 |
| 4.2 | 1.32 | 10 | 35.6 | 15 | 13.3 | 0 | 0 |
| Reference | | | | | | | |
| untreated | | | | | | | |

It is surprising that good mechanical fiber data are maintained, even after a double solvent exchange and high loading according to the invention with a substance that is extraneous to the cellulose structure.

### Example 5

### Binding of Olive Oil from a Water/Ethanol Emulsion

The impregnation efficiency K′ for olive oil in a water/ethanol emulsion was determined to be 0.33. 212 g never dried Lyocell fiber (dry weight 100 g) with a titer of 1.3 dtex were impregnated in an emulsion consisting of 1000 g olive oil, 480 g ethanol, 368 g water, and 40 g emulator (Emulsogen T, Clariant) for 15 min in the ultrasound bath at 50° C., and then compressed in the padding machine at 1 bar. The wet fiber mass was divided up, and fixed under different conditions. Then, the fibers were dried under different conditions and subjected to 3 simulated household washes at 60° C. with intermediate rinsings in hard water (conditions and results, see Table 5). The fibers that had been fixed in the Labomat and dried at 105° C. for 4 h had a titer of 1.4 dtex, a strength of 25.9 cN/tex, and an elongation of 9.0%.

TABLE 5
Binding of olive oil from a 50% emulsion in ethanol/water

| Treatment | | | | |
|---|---|---|---|---|
| | | | Coating (%) | |
| Fixing | | Drying | After | After 3 |
| Apparatus | Temp./time | Temp./Time | drying | washes |
| Without | — | 105° C./4 h | 24.7 | 0.3 |
| Steam treatment | 100° C./5 min | 105° C./4 h | 25.2 | 0.3 |
| Steam treatment | 80° C./2 h | 105° C./4 h | 27.2 | 1.9 |
| Steam treatment | 100° C./1 h | 105° C./4 h | 30.3 | 4 |
| Labomat | 130° C./1 h | 25° C./24 h | 31.9 | 0.5 |
| Labomat | 130° C./1 h | 60° C./18 h | 31.5 | 0.2 |
| Labomat | 130° C./1 h | 105° C./4 h | 32.6 | 11.7 |

This example also shows that, according to the invention, good mechanical fiber data are maintained, in spite of high loading with a substance that is extraneous to the cellulose structure.

### Example 6

### Binding of Olive Oil from an Aqueous Emulsion

The impregnation efficiency K′ for olive oil in an aqueous emulsion was determined to be 0.24. 207.3 g never dried Lyocell fibers (dry weight 100 g) with a titer of 1.3 dtex were impregnated in a 1st test series (Examples 6.1-6.2) in an emulsion consisting of 1000 g olive oil, 893 g water, 60 g emulator (Emulsogen T, Clariant) for 15 min in the ultrasound bath at 50° C., and then compressed in the padding machine at 1 bar. The wet fiber mass was divided and fixed under different conditions. Subsequently, the fibers were dried under different conditions and subjected to 3 simulated household washes at 60° C. with intermediate rinsings in hard water (conditions and results, see Table 6a). This example as well shows that good mechanical fiber data are maintained, even with high loading with a substance that is extraneous to the cellulose structure.

TABLE 6a
Binding of olive oil from a 50% emulsion in water

| | Treatment | | | | |
|---|---|---|---|---|---|
| | | | | Coating (%) | |
| | Fixing | | Drying | After | After 3 |
| Example | Apparatus | Temp./time | Temp./time | drying | washes |
| 6.1 | Steaming | 100° C./1 h | 105° C./4 h | 38.2 | 6.5 |
| | apparatus | | | | |
| 6.2 | Labomat | 130° C./1 h | 105° C./4 h | 28.4 | 20.3 |

In a 2nd test series (Example 6.3-6.8), the samples which had been treated with steam or in the Labomat, as described above, were subjected, prior to the first drying, to an intermediate wash (40° C., water, liquor ratio 1:50 with mechanical movement), in order to remove the excess oil. As a result, the dried fibers were easier to open. A relatively high remaining olive oil coating after 3 washes and thus a good wash resistance were found only in Examples 6.5 and 6.8. This test series shows the great influence of a well-adjusted combination of the fixing and drying conditions.

TABLE 6b
Binding of olive oil from a 50% emulsion in water
with an intermediate wash prior to the first drying

| | | | | Coating (%) | |
|---|---|---|---|---|---|
| | Fixing | | Drying | After | After 3 |
| Example | Apparatus | Temp./time | Temp./time | drying | washes |
| 6.3 | Steaming | 100° C./10 min | 25° C./24 h | 7.9 | 0.3 |
| | apparatus | | | | |
| 6.4 | Steaming | 100° C./10 min | 60° C./18 h | 9.9 | 0.3 |
| | apparatus | | | | |
| 6.5 | Steaming | 100° C./10 min | 105° C./4 h | 9.2 | 2.2 |
| | apparatus | | | | |
| 6.6 | Labomat | 130° C./1 h | 25° C./24 h | 13.4 | 0.3 |
| 6.7 | Labomat | 130° C./1 h | 60° C./18 h | 9.9 | 0.4 |
| 6.8 | Labomat | 130° C./1 h | 105° C./4 h | 11 | 6.4 |

### Example 7

### Binding of Gelatin

Gelatin is a protein having a molecular weight of typically approximately 15,000-250,000 g/mol, which is obtained primarily by hydrolysis of the collagen contained in the skin and bones of animals, under acidic conditions (“type A gelatin”) or alkaline conditions (“type B gelatin”). Collagen is contained in many animal tissues as structural substance. Native collagen has a molecular weight of approximately 360,000 g/mol.

In water, particularly with heating, gelatin at first swells strongly, and then it dissolves in the water forming a viscous solution which hardens to a jelly-like substance at approximately 1 wt % below approximately 35°. Gelatin is insoluble in ethanol, ethers and ketones, and soluble in ethylene glycol, glycerol, formamide and, acetic acid.

Collagen and gelatin are used in medicine to modify surfaces in order to render them biocompatible. However, such surfaces are very sensitive. By means of the method according to the invention, the mechanical properties of cellulose are combined with the biocompatibility of gelatin surfaces. Films, as molded bodies, are appropriate precisely for such uses. In cosmetics, collagen and its hydrolysis products are used as moisturizer and as skin protection substance.

An important property of gelatin is that it has a low viscosity (sol state) in solutions above approximately 60° C., but it is converted to a gel state during the cooling. Commercially available gelatin types differ primarily in the gel strength, which is measured in ° bloom which is a mechanical measure of the penetration of a weight into the gel. The gel strength is associated with the (mean) molecular weight of the gelatin. Thus a gel strength of 50-125 (low bloom) corresponds to a mean molecular weight of 20,000-25,000, a gel strength of 175-225 (medium bloom) to a mean molecular weight of 40,000-50,000, and a gel strength of 225-325 (high bloom) to a mean molecular weight of 50,000-100,000 (data according to Sigma-Aldrich, 2008, for different gelatin types).

TABLE 7a
Properties of the gelatin types used

| Name | Manufacturer | Product No. | Origin | Gel strength |
|---|---|---|---|---|
| Food gelatin | Gelita, DE | — | — | 60-80 |
| Low gel strength | Fluka | 48720 | Pigskin | 60 |
| Medium gel | Fluka | 48722 | Pigskin | 170-190 |
| strength | | | | |
| High gel strength | Fluka | 48724 | Pigskin | 240-270 |

For all the gelatin types used, a mean moisture content of 12% under laboratory conditions (25° C., 40% air humidity) and a nitrogen content of 18% (absolutely anhydrous) were measured. Table 7a shows additional properties of these gelatin types.

### Example 7a

### Influence of the Drying Temperature

108 g never dried Lyocell fibers (at 140% humidity, dry weight 45 g) with titer 1.3 dtex were impregnated with a solution of 10% “low gel strength” gelatin in water at the liquor ratio of 1:20 at 50° C. for 15 min. This gelatin had an impregnation efficiency K′ in water of 0.46. The fibers were compressed at 1 bar in the padding machine, and treated with steam in a closed plastic bag at 80° C. for 1 hour. Subsequently the fibers were divided in 3 portions, and dried under different conditions (Table 7b). In order to remove excess gelatin that was not bound to the fiber the dry fibers were subjected to a prewash with water (LR 1:50, 60° C., 30 min) in the Labomat, and dried at 60° C./for 18 hours. Then, the wash resistance was checked by means 3 alkaline washes. The gelatin coating was determined by nitrogen elemental analysis. Results, see Table 7b.

TABLE 7b
Production of gelatin-containing fibers (Example 7a)

| | | Drying | | Gelatin coating | | | |
|---|---|---|---|---|---|---|---|
| | Treatment | Temperature | Time | After | After | 1st | 3rd |
| Example | with steam | (° C.) | (h) | drying | prewash | wash | wash |
| 7a.1 | 80° C./1 h | 60° C. | 18 | not | 8.3 | 1.09 | 0.65 |
| | | | | known | | | |
| 7a.2 | 80° C./1 h | 80° C. | 4 | not | 8.9 | 1.25 | 0.74 |
| | | | | known | | | |
| 7a.3 | 80° C./1 h | 105° C. | 3 | not | 7.7 | 1.38 | 0.97 |
| | | | | known | | | |

### Example 7b

### Influence of the Conditions During the Treatment with Steam

125 g never dried Lyocell fibers (at 108% moisture, dry weight 60 g) with titer 1.3 dtex were impregnated with a solution of 20% “food gelatin” gelatin in water at the liquor ratio of 1:20 at 60° C. for 3 hours. This gelatin had an impregnation efficiency K′ in water of 0.31. The fibers were compressed at 1 bar in the padding machine, and treated with steam in the laboratory steaming apparatus at 100° C. either for 10 minutes or for 1 hour. Subsequently, the fibers were washed in water (LR 1:100, 40° C.) in order to remove excess gelatin that was not bound to the fiber, and subsequently they were dried at 105° C./for 4 hours. Then the dried fibers were prewashed with water (LR 1:50, 60° C., 30 min) in the Labomat, and dried at 60° C./for 18 hours. Subsequently, the wash resistance was checked by means of 3 alkaline washes. The gelatin coating was determined by nitrogen elemental analysis. Result, see Table 7c.

TABLE 7c
Preparation of gelatin-containing fibers (Example 7b)

| | | Drying | | Gelatin coating | | | |
|---|---|---|---|---|---|---|---|
| | Treatment | Temperature | Time | After | After | 1st | 3rd |
| Example | with steam | (° C.) | (h) | drying | prewash | wash | wash |
| 7b.1 | 105° C./10 min | 105 | 4 | 5.75 | 3.54 | 1.96 | 1.82 |
| 7b.2 | 105° C./10 min | 105 | 4 | 14.49 | 7.03 | 3.39 | 2.99 |

### Example 7c

### Influence of the Different Gelatin Types

66 g never dried Lyocell fibers (at 120.4% humidity, dry weight 30 g) with titer 1.3 dtex were impregnated with a solution of 10% or 3% gelatin of different types (Table 7d) in water at the liquor ratio of 1:20 at 60° C. for 15 min. The gelatin types “food gelatin,” “low gel strength,” “medium gel strength,” and “high gel strength” had impregnation efficiencies K′ in water of 0.31; 0.46; 0.78 and 0.71. The fibers were compressed at 3 bar in the padding machine and treated with steam in the laboratory steaming apparatus at 100° C. for 10 minutes. Subsequently, the fibers were washed in water (LR 1:100, 40° C.) in order to remove the excess gelatin that was not bound to the fiber, and subsequently dried at 105° C./for 4 hours. In this example, the dried fibers were not prewashed with water. Subsequently, the wash resistance was checked by means of 3 alkaline washes. The gelatin coating was determined by nitrogen elemental analysis. Results, see Table 7d.

TABLE 7d
Preparation of gelatin-containing fibers (Example 7c)

| | | | | Drying | | Gelatin coating | |
|---|---|---|---|---|---|---|---|
| | | Concentration | Treatment | Temperature | Time | After | 3rd |
| Example | Gelatin type | (%) | with steam | (° C.) | (h) | drying | wash |
| 7c.1 | Food gelatin | 10 | 100° C./10 min | 105 | 4 | 2.92 | 1.24 |
| 7c.2 | Low gel | 10 | 100° C./10 min | 105 | 4 | 0.93 | 0.45 |
| | strength | | | | | | |
| 7c.3 | Medium gel | 10 | 100° C./10 min | 105 | 4 | 1.82 | 0.75 |
| | strength | | | | | | |
| 7c.4 | High gel | 10 | 100° C./10 min | 105 | 4 | 1.85 | 0.76 |
| | strength | | | | | | |
| 7c.5 | Food gelatin | 3 | 100° C./10 min | 105 | 4 | 2.49 | not |
| | | | | | | | known |

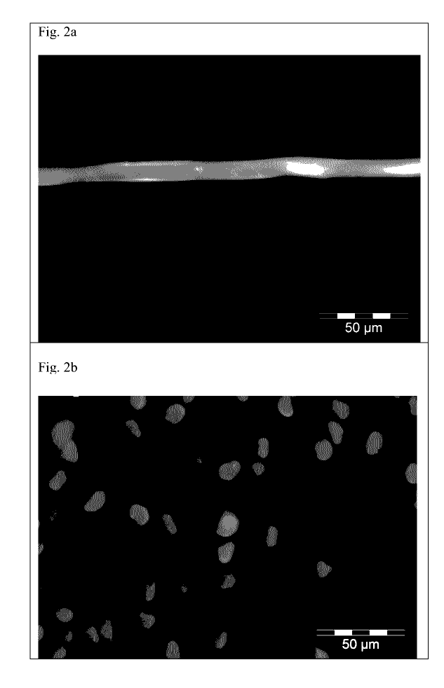

To visualize the distribution of the gelatin on and in the fiber, the protein was dyed selectively with FITC (fluorescein isothiocyanate). The dye forms a covalent bond with the amino groups of the protein. FIGS. 2a and 2b show, as examples for the fibers of Example 7c.4, that the protein was present throughout the entire fiber cross section, and enriched on the surface.

Example 7 shows in summary that gelatin is also fixed permanently in the fiber by the method according to the invention, on the one hand, and that the gelatin quantity required for the functionality can be kept low due to the enrichment on the surface, on the other hand.

### Example 8

### Binding of Whey Protein

Whey proteins are extracted from milk. They constitute the water-soluble, unaggregated component of the milk proteins, and consist of approximately 50% (3-lactoglubulin, 20% α-lactalbumin, and a few other proteins. In contrast to caseins, they do not form micelles and they have relatively low molecular weights in the range of 15,000-25,000. Commercially available milk proteins contain certain quantities of lactose and small proportions of milk fat.

208 g never dried Lyocell fibers (100 g atro at 108.3% humidity, type 1.3 dtex/38 mm) were impregnated with a 15% solution of whey protein (Globulac 70 N, Meggle GmbH, Wasserburg/Germany, protein content>70%, impregnation efficiency K′=0.23 measured in water) for 10 min at 50° C. After compressing at 3 bar in the padding machine, the nonwoven fabric was divided. One half was not treated with steam (fiber 8.1). The other half was treated with steam at 100° C. (5 min) (fiber 8.2). The fibers were washed out in a glass beaker with water at a liquor ratio of 1:100 and 40° C. The moist fibers were brightened with 7.5 g/L avivage B 304 at LR 1:20. Subsequently, the fibers were dried at 60° C. The dry fibers were easy to open. They were carded, spun into a yarn, and a knitted fabric was produced. The whey protein coating was determined by nitrogen elemental analysis. A nitrogen content in the protein of 15% was assumed, which is the known nitrogen content of caseins.

The results are listed in Table 8. One can clearly see that the treatment with steam in this case as well was a prerequisite for fixation of the protein to the fiber, which ensures, on the one hand, a higher content of functional substance in the fiber before further processing, and, on the other hand, it also prevents major losses of functional substance during further processing in the textile chain as well as in daily use. After the 6th wash, the protein content of the fiber that had not been treated with steam was already below the detection limit and could therefore not be determined.

TABLE 8
Production of whey protein-containing fibers

Protein content (coating on fiber)

| | Fiber 8.1 | Fiber 8.2 |
|---|---|---|
| Step | not treated with steam | treated with steam |
| Before avivage | 0.75 | 4.04 |
| After avivage | 0.17 | 3.47 |
| Knitted fabric | 0.08 | 1.68 |
| After 3 washes | 0.06 | 0.97 |
| After 6 washes | not known | 0.95 |

To visualize the distribution of the whey protein on and in the fiber, the protein was selectively dyed with FITC (fluorescein isothiocyanate). The dye forms a covalent bond with the amino groups of the protein.

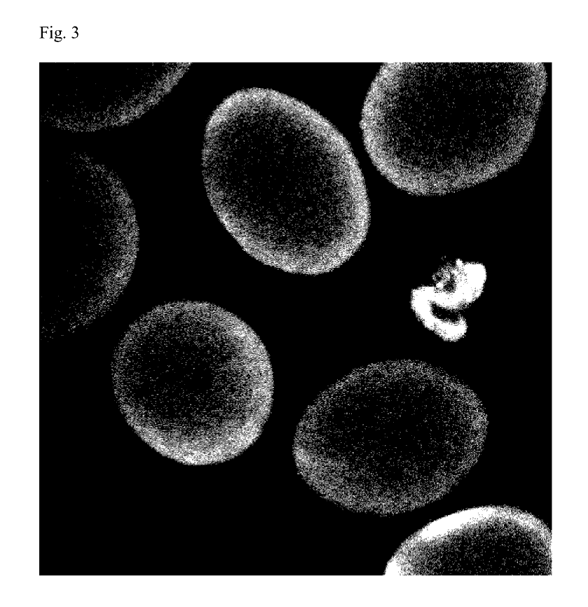

FIG. 3 shows, as an example for the fibers of Example 8, that the protein was present throughout the entire fiber cross section, and enriched on the surface.

### Example 9

### Binding of Polyacrylic Acids

Polyacrylic acid and polymethacrylic acid are hydrophilic, water-soluble polymers which are commonly used in the technology as thickening, flocculation and dispersion aids. By means of a graft reaction of acrylic acid on cellulose surfaces, derivatized cellulose fibers can be produced, for example, the commercially available “Deocell” fiber which is used to absorb odors. However, these reactions are technologically involved and therefore expensive to carry out.

Never dried Lyocell fibers were impregnated for 15 min in the ultrasound bath with 25% aqueous solution of the respective acyl compound mentioned in Table 11, treated with steam for 20 min at 100° C., washed with 0.025M H₂SO₄ until the pH of the solution was slightly acidic, then rinsed 5 times with demineralized water, subsequently dried for 1 h at 105° C., and furthermore for 18 h at 60° C. The acyl compounds had impregnation efficiencies K′ in water between 0.52 (molecular weight 9500) and 0.62 (molecular weight 100,000). The bound quantity of polymer was determined by titration of the carboxyl groups and found to be between pH 3.5 and pH 9. The wash resistance was determined by 3 washes (simulated household wash). The results are presented in Table 9.

Thus, fibers were produced which, particularly at higher molecular weights, present a wash resistance similar to that of fibers obtained by a graft reaction, for example, by the formation of a covalent bond.

The effectiveness of the absorption of odors was tested on the resulting fibers. For this purpose, samples were sprayed with ammonia solutions at different concentration and then the odor intensity was evaluated by smelling. The odor intensity was reported using the grades (0=not noticeable, 5=strong) used in the table.

TABLE 9
Result of the binding of polyacrylic acid or polymethacrylic acid

| | Application As wt % | | | On | | | | | |
|---|---|---|---|---|---|---|---|---|---|
| | carboxyl groups | | | fiber | | | | | |
| | | 3 | | titr. | Odor intensity at | | | | |
| | Start | washes | Loss | COOH | (mg NH3/g) | | | | |
| Sample | % | % | % | % | 0.6 | 1.2 | 3 | 4.2 | 10.2 |
| Lyocell reference 1.3 | 0 | 0 | 0 | 0 | 5 | not | not | not | not |
| dtex untreated | | | | | | known | known | known | known |
| Deocell | 7.7 | 5.0 | 34 | 7.7 | 0 | 0 | 0 | 0 | 0 |
| (commercial, by | | | | | | | | | |
| graft reaction) | | | | | | | | | |
| Polymethacrylic acid | 1.2 | 0.5 | 62 | 1.2 | 0 | not | 2 | not | not |
| Na salt MW 9500 | | | | | | known | | known | known |
| Polyacrylic acid | 0.9 | 0.4 | 54 | 0.9 | 0 | not | 3.5 | not | not |
| MW | | | | | | known | | known | known |
| approximately 5000 | | | | | | | | | |
| partially salt | | | | | | | | | |
| Polyacrylic acid Na | 1.3 | 0.5 | 61 | 1.3 | 0 | not | 2.5 | not | not |
| salt MW | | | | | | known | | known | known |
| approximately | | | | | | | | | |
| 15,000 | | | | | | | | | |
| Polyacrylic acid | 2.8 | 1.5 | 47 | 2.8 | 0 | not | 0 | 2 | 2 |
| MW approximately | | | | | | known | | | |
| 100,000 | | | | | | | | | |
| Polyacrylic acid | 1.4 | 0.9 | 32 | 1.4 | 0 | not | 2 | not | not |
| MW | | | | | | known | | known | known |
| approximately | | | | | | | | | |
| 250,000 | | | | | | | | | |

### Example 10

### “Slow Release” Test with Vitamin E in Wax

Analogously to Example 1, 50 g dry weight of a never dried Lyocell fiber with a titer of 1.3 dtex or 6.7 dtex without prior solvent exchange was treated with a solution of 10% wool wax alcohol (Lanowax EP, Company Parmentier, Frankfurt, Del.) in isopropanol at a liquor ratio of 1:20 for a duration of 10 min. However, in this case, the wax solution was enriched with 5.33 mg/kg tocopherol acetate (vitamin E) with respect to wax. The solvent exchange here occurred in situ, and the residual water content in the entire preparation was calculated to be 6.8%. The fibers were separated by compressing in the padding machine at 3 bar from the excess wax solution, and dried for 4 hours at 105° C. The fibers obtained were subjected to 3 washes at 60° C. (simulated household wash). The wax content was determined by gravimetry and by extraction in ethanol. The vitamin E determination was carried out on the extract using HPLC.

TABLE 10
Preparation of a wool wax alcohol-containing fiber. Coatings in % after extraction

| | Fiber | | | | | |
|---|---|---|---|---|---|---|
| | Fiber 1.3 dtex | | | Fiber 6.7 dtex | | |
| | Preliminary treatment | | | | | |
| | Never dried | | | Never dried | | |
| | | | Vitamin E | | | Vitamin E |
| | | Vitamin E | Efficiency | | Vitamin E | Efficiency |
| | Coating | (mg/kg | % or use | Coating | (mg/kg | % or use |
| Steps | (%) | fiber) | (wax) | (%) | fiber) | (wax) |
| After | 7.4 | 328. | 83 | 7.1 | 293 | 77 |
| drying | | | | | | |
| After 2nd | 6.7 | 209. | 61 | 4.5 | 129 | 54 |
| wash | | | | | | |
| After 3rd | 6.4 | 188. | 52 | 4.3 | 113 | 50 |
| wash | | | | | | |
| After 3rd | red | | | red | | |
| wash- | | | | | | |
| dyeing with | | | | | | |
| rhodamine B | | | | | | |

It was observed here that vitamin E is retained together with the wax in the fiber, but that the vitamin E load decreases during the washing. From this one can conclude that this method can be used in order to introduce fat-soluble, skin-care active ingredients in a substrate from wax into the fiber, active ingredients which are subsequently released slowly from the wax-fiber matrix. The wax probably forms lipophilic nanocapsules in the fiber. Thus, the fiber is a system for the controlled active ingredient release (a so-called “slow release” system).

In this manner, it is even possible to load and remove functional substances, for example, vitamins or scents, multiple times into respectively from the fibers.

### Example 11

### Binding of Permethrin from a Solvent

Permethrin is a synthetic insecticide from the pyrethroid group. It is used extensively due to its broad effectiveness against insects, and the low toxicity for warm-blooded organisms, including humans. In textiles, permethrin is used, for example, to provide protection against being eaten by moths (carpets), and on clothing for protection from pathogens (vectors), such as, mosquitoes and ticks.

Permethrin was introduced into never dried Lyocell fibers in two different ways: using a prior solvent exchange, and directly onto the water-containing, never dried fibers.

### Example 11a

### With Solvent Exchange In Situ

15 g dry weight of a never dried Lyocell fiber with a titer of 1.3 dtex were treated, without prior solvent exchange, with a solution of 2% or 5% permethrin (P100 from Thor Chemie (Speyer, Del.)) in isopropanol at a liquor ratio of 1:20 at room temperature for 15 minutes. Here, the solvent exchange took place in situ. The residual water content in the entire preparation was calculated to be 5.7%. The fiber was separated by compressing in the padding machine at 3 bar from the excess permethrin solution, and dried at 105° C. for 4 hours or at 60° C. for 18 hours. The fibers obtained were subjected to simulated household washes.

The permethrin coating was subsequently determined by extraction in ethanol (Soxhlet) and subsequent HPLC analysis.

TABLE 11a
Preparation of a permethrin-containing
fiber without prior solvent exchange

| Test | 11.1 | 11.2 | 11.3 | 11.4 |
|---|---|---|---|---|
| Permethrin | 2 | 2 | 5 | 5 |
| concentration (%) | | | | |
| Drying | 60° C./18 h | 105° C./4 h | 60° C./18 h | 105°/4 h |
| Coating (%) | 2.05 | 2.16 | 4.68 | 4.31 |
| Impregnation | 1.03 | 1.08 | 0.94 | 0.86 |
| efficiency | | | | |
| Coating after | 1.80 | 1.99 | 2.91 | 2.67 |
| 1 wash (%) | | | | |
| Coating after | 1.60 | 1.50 | not known | not known |
| 10 washes | | | | |
| Coating after | 0.82 | 1.13 | not known | not known |
| 50 washes | | | | |

### Example 11b

### With Prior Solvent Exchange

20 g dry weight of a never dried Lyocell fiber with a titer of 1.3 dtex were treated with 400 mL isopropanol for 1 hour for the solvent exchange. The excess solvent was removed by compression in the padding machine at 3 bar.

Subsequently, a treatment was carried out with a solution of 2% or 5% permethrin (P100 from Thor Chemie (Speyer, Germany)) in isopropanol at a liquor ratio of 1:20 at room temperature for 15 minutes. The fiber was separated by compressing in the padding machine at 3 bar from the excess permethrin solution, and dried at 105° C. for 4 hours or at 60° C. for 18 hours. The resulting fibers were subjected to simulated household washes

The permethrin coating was determined by extraction in ethanol (Soxhlet) and subsequent HPLC analysis.

TABLE 11b
Preparation of a permethrin-containing
fiber with prior solvent exchange

| Test | 11.5 | 11.6 |
|---|---|---|
| Permethrin concentration (%) | 2 | 5 |
| Drying | 60° C./18 h | 60° C./18 h |
| Coating (%) | 1.78 | 4.53 |
| Impregnation efficiency | 0.89 | 0.91 |
| Application after 1 wash | 1.02 | 3.47 |

On the industrial scale, this method can be carried out in a flock dyeing apparatus, for example.

### Example 12

### Modification of Cellulose Granulates and Powders

Besides the functionalization of cellulose fibers according to the method of the invention, which has already been described in detail, cellulose granulates or powders were also treated. The production of the granulate or powder here was carried out according to the method described in WO 2009/036480. The functionalization occurred analogously to Example 2 with polyDADMAC, i.e., it was first impregnated, then treated with steam, and subsequently the sample was dried. This dry sample was washed under weakly alkaline conditions, washed again with water, and dried again. In test 12.1, never dried cellulose granulate (particle size approximately 1-2 mm), and in test 12.2 already dried and ground powder (x₅₀=50 μm, x₉₀=120 μm), was used as starting material. For test 12.3, the loaded granulate from test 12.1 was dried and also ground to a powder using an impact crusher (UPZ 100, Hosokawa Alpine), resulting in a powder with x₅₀=60 μm, and x₉₀=125 μm. The loading of the particles produced in each case with polyDADMAC was measured via the nitrogen content, as described in Example 2. The results are summarized in Table 13. Washing or dyeing tests, which would have been similar to those carried out on fibers, were not carried out on the granulate or powder. One can clearly see that considerably more polyDADMAC can be applied to the never dried cellulose granulate than to an already dried cellulose powder. The polyDADMAC content also dose not change and remains high if the granulate is dried and ground.

TABLE 12
Modification of cellulose granulates and powders

| Test | polyDADMAC content on particles [%] |
|---|---|
| 12.1 | 3.4 |
| 12.2 | 1.8 |
| 12.3 | 3.4 |

1. A molded cellulose body comprising a functional substance having an impregnation efficiency K′ of less than 10, preferably less than 5, wherein the molded cellulose body is produced by a method wherein introduction of the functional substance into a never dried molded cellulose body occurs during manufacture after a molding step.

2. A molded cellulose body comprising a functional substance distributed in the molded body, wherein the concentration of the functional substance has a continuous, nonconstant distribution with a minimum in a center of the molded body.

3. The molded cellulose body according to claim 2, wherein the functional substance has an impregnation efficiency K′ of less than 10, and preferably less than 5.

4. The molded cellulose body according to claim 1, wherein the functional substance in NMMO does not interfere with NMMO recovery or affect spinning safety.

5. The molded cellulose body according to claim 1, wherein the functional substance is selected from the substance group consisting of:
a. hydrophobic (lipophilic) substances having a low or high molecular weight, particularly oils, such as, olive oil, grapeseed oil, sesame oil, linseed oil, fats, such as, coconut fat, paraffins and other hydrocarbons, waxes, such as, wool wax and its derivatives, beeswax, carnauba wax, jojoba oil, resins, such as, shellac, oils, fats and waxes which are used as substrates for fat-soluble active ingredients, particularly for skin-care vitamins, ceramides, fire retardant substances which are soluble or emulsifiable in organic solvents, dyes which are soluble in special solvents, for example, the so-called “High-VIS” dyes, insecticides, particularly pyrethroids, such as, permethrin;
b. hydrophilic, uncharged polymers, particularly neutral polysaccharides, particularly xylan, mannan, starches and their derivatives;
c. anionic polymers, particularly polyacrylic acid, polymethacrylic acid;
d. polysaccharides having anionic groups, such as, polygalacturonates (pectin), carrageenan, hyaluronic acid;
e. anionic derivatives of neutral polymers;
f. cationic polymers, particularly polyDADMAC, polyamino acids, cationic derivatives of neutral polymers, z particularly cationized starches;
g. proteins, particularly structural proteins, such as, gelatin, collagen, milk proteins (caseins, whey proteins), enzymes or functional proteins; and
h. combinations of complex natural substances, particularly active, such as, Aloe vera, grapeseed extract or oil, antioxidant mixtures of plant origin, etheric oils or wellness preparations, such as, Ginseng.

6. Use of molded bodies according to claim 1, wherein the product is selected from the group consisting of yarns, textiles, gels and composite materials.

7. Use of molded bodies according to claim 1, wherein the product is selected from the group consisting of cosmetic products, wellness products, medicinal products, fire retardant products, and dyed products, particularly High-Vis dyed products.

8. A method for introducing a functional substance into a molded cellulose body comprising introducing the functional substance into a never dried molded cellulose body during its manufacture after a molding step.

9. The method according to claim 8, wherein the functional substance has a low impregnation efficiency.

10. The method according to claim 8, wherein the functional substance has an impregnation efficiency K′ which is less than 10, and preferably less than 5.

11. The method according to claim 8, wherein the functional substance is in a solution or emulsion.

12. The method according to claim 8, wherein the molded cellulose body is selected from the group consisting of a fiber, a film, a granulate, a powder, a fibride, a spunbond material, sponge, aerogel and hydrogel.

13. The method according to claim 8, wherein the molding step occurs by an extrusion of a cellulose-containing spinning solution through an extrusion nozzle.

14. The method according to claim 13, wherein the cellulose-containing spinning solution is produced according to a direct dissolution method, preferably according to a Lyocell method in NMMO.

15. The method according to claim 8, wherein the introducing of the functional substance occurs between exit of the molded cellulose body from a precipitation bath and drying.

16. The method according to claim 14, wherein the introducing of the functional substance occurs after a solvent exchange.

17. The method according to claim 8, wherein the molded cellulose body is treated with steam after the introducing of the functional substance.

18. A method for producing a molded cellulose body from a cellulosic-containing spinning solution comprising the steps of:
molding said cellulose-containing spinning solution to provide molded cellulose bodies;
precipitating the molded cellulose bodies;
washing the molded cellulose body; and
optionally drying the molded cellulose body,
wherein a functional substance that is electrically neutral or negatively charged is introduced into a never dried moulded cellulose body during its manufacture after the molding step.

19. The method according to claim 18, wherein the cellulose-containing spinning solution is produced by a direct dissolution method.

20. The method according to claim 18, wherein the functional substance has a low impregnation efficiency.

21. The method according to claim 18, wherein the functional substance has an impregnation efficiency K′ which is less than 10, preferably less than 5.

22. The method according to claim 18, wherein the functional substance is in a solution or an emulsion.

23. The method according to claim 18, wherein the molding step occurs by an extrusion of the cellulose-containing spinning solution through an extrusion nozzle.

24. The method according to claim 18, wherein introducing of the functional substance occurs between an exit of the moulded cellulose body from a precipitation bath and drying.

25. The method according to claim 18, wherein introducing of the functional substance occurs after a solvent exchange.

26. The method according to claim 18, wherein the molded cellulose body is treated with steam after introducing of the functional substance.

27. A molded cellulose body comprising a functional substance, wherein the cellulose molded body is obtainable by a method according to claim 18.

28. The molded cellulose body according to claim 27, wherein a concentration of the functional substance has a continuous, non-constant distribution with a minimum in the center of the molded body.

29. The molded cellulose body according to claim 27, wherein the functional substance has an impregnation efficiency K′ of less than 10, preferably less than 5.

30. The molded cellulose body according to claim 27, wherein the functional substance in NMMO is not sufficiently stable, does not interfere with NMMO recovery or affect spinning safety.

31. The molded cellulose body according to claim 27, wherein the functional substance is selected from the substance group consisting of:
a. hydrophobic (lipophilic) substances having a low or high molecular weight, particularly oils such as olive oil, grapeseed oil, sesame oil, linseed oil, fats such as coconut fat, paraffins and other hydrocarbons, waxes such as wool wax and its derivatives, beeswax, carnauba wax, jojoba oil, resins such as shellac, oils, fats and waxes which are used as substrates for fat-soluble active ingredients, particularly for skin-care vitamins, ceramides, fire retardant substances which are soluble or emulsifiable in organic solvents, dyes which are soluble in special solvents, for example, the so-called “High-Visibility” dyes, insecticides, particularly pyrethroids such as permethrin;
b. hydrophilic, uncharged polymers, particularly neutral polysaccharides, particularly xylan, mannan, starches and their derivatives;
c. anionic polymers, particularly polyacrylic acid, polymethacrylic acid;
d. polysaccharides having anionic groups such as polygalacturonates (pectin), carrageenan, hyaluronic acid;
e. anionic derivatives of neutral polymers;
f. proteins, particularly structural proteins such as gelatine, collagen, milk proteins (caseins, whey proteins), enzymes or functional proteins; and
h. combinations of complex natural substances, particularly active, such as Aloe vera, grape seed extract or oil, antioxidant mixtures of plant origin, essential oils or Ginseng.

32. The molded cellulose body according claim 27, wherein the molded cellulose body is selected from the group consisting of a fiber, a film, a granule, a powder, a fibrid, a spunbond, sponge, airgel, and hydrogel.
